(19) United States
(12) Patent Application Publication
(10) Pub. No.: US 2009/0172577 A1
(43) Pub. Date: Jul. 2, 2009

(54) TERMINAL AND METHOD FOR CONFIGURING GRAPHIC USER INTERFACE THEREOF

(75) Inventors: Min Suk Kim, Seoul (KR); Joong Hun Kwon, Seoul (KR); Hyang Ah Kim, Seoul (KR); Byung Joo Kim, Seoul (KR); Sun Ho Kim, Seoul (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/341,903

(22) Filed: Dec. 22, 2008

(30) Foreign Application Priority Data
Jan. 2, 2008 (KR) 10-2008-0000138

(51) Int. Cl. G06F 3/048

(52) U.S. Cl. 715/765

(57) ABSTRACT

A terminal and a method for configuring a graphic user interface (GUI) thereof are disclosed. The method includes determining which one of a first mode and a second mode is selected when a GUI configuring function is selected, selecting at least one of an image and a color if the first mode is selected, selecting a color if the second mode is selected and, if an image is required, an image, extracting a color code using the selected color and/or image, configuring the extracted color code and the selected image as a GUI set, and storing the GUI set and applying the GUI set to a GUI element.

### CROSS REFERENCE TO RELATED APPLICATION

This application claims priority from and the benefit of Korean Patent Application No. 10-2008-0000138, filed on Jan. 2, 2008, which is hereby incorporated by reference for all purposes as if fully set forth herein.

### BACKGROUND OF THE INVENTION

1. Field of the Invention

The present invention relates to a terminal and a method for configuring a graphic user interface thereof, and more particularly, to a terminal and a method for configuring a graphic user interface that may configure the graphic user interface according to a user's desire.

2. Discussion of the Background

Generally, a menu system of a terminal provides a graphic user interface (GUI). However, the menu system may be unchangeable because the menu system may be exclusively designed for the terminal according to a manufacturer's specification. Therefore, such a terminal may be unable to fully satisfy individual requirements and aesthetic desires of a terminal user.

Accordingly, users having the same terminal may have to use menu systems of the same design. In particular, individual users may be unable to configure the menu system according to their desires, because various models of terminals made by a given manufacturer generally provide menu systems in similar designs.

### SUMMARY OF THE INVENTION

The present invention provides a terminal and a method for configuring a GUI thereof that may optimize the GUI according to a user's desire.

The present invention also provides a terminal and a method for configuring a GUI thereof in which the GUI may be automatically optimized if at least one of a background image and a color is selected.

The present invention also provides a terminal and a method for configuring a GUI thereof in which each GUI element may be configured in a form desired by a user.

The present invention also provides a terminal that has a small storage capacity and in which a desired GUI may be configured and stored.

The present invention further provides a terminal and a method for configuring a GUI thereof in which a stored GUI set is transmitted to another terminal through a communicating unit and activated according to generation of a configured event.

Additional features of the invention will be set forth in the description which follows, and in part will be apparent from the description, or may be learned by practice of the invention.

The present invention discloses a method for configuring a GUI in a terminal including determining which one of a first mode and a second mode is selected when a GUI configuring function is selected, selecting at least one of an image and a color if the first mode is selected, selecting a color and, if an image is required, an image if the second mode is selected, extracting a color code using the selected color and/or image, configuring the extracted color code and the selected image as a GUI set, and storing the GUI set, and applying the GUI set to a GUI element.

The present invention also discloses a terminal including a memory unit, a control unit, and a GUI set storage unit. The memory unit stores a GUI element, an image, and a color. The control unit selects at least one of an image and a color if a first mode of a GUI configuring function is selected, and selects a color and, if an image is required, an image if a second mode of the GUI configuring function is selected. The control unit also extracts a color code using the selected color and/or image, configures the extracted color code and the selected image as a GUI set, and applies the GUI set to the stored GUI element. The GUI set storage unit stores the GUI set.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A is a block diagram showing a configuration of a terminal for configuring a GUI according to an exemplary embodiment of the present invention.

FIG. 1B is a block diagram showing a configuration of a GUI set storage unit of the terminal of FIG. 1A.

FIG. 2A and FIG. 2B are flow charts showing a method of configuring a GUI in a terminal according to another exemplary embodiment of the present invention.

FIG. 3A, FIG. 3B, FIG. 3C, and FIG. 3D are flow charts showing a process of configuring a GUI in a first mode in the method of FIG. 2A and FIG. 2B.

FIG. 4A, FIG. 4B, FIG. 4C, FIG. 4D, FIG. 4E, FIG. 4F, FIG. 4G, FIG. 4H, FIG. 4I, and FIG. 4J are screens displayed while configuring a GUI in a first mode in the process of FIG. 3A, FIG. 3B, FIG. 3C, and FIG. 3D.

FIG. 5A and FIG. 5B are flow charts showing a process of configuring a GUI in a second mode in the method of FIG. 2A and FIG. 2B.

FIG. 6 is a screen displayed while configuring a GUI in a second mode in the process of FIG. 5A and FIG. 5B.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

A terminal according to exemplary embodiments of the present invention is a terminal having a display device, and may be any information or telecommunication equipment, multimedia equipment, or application thereof. For example, the terminal may be a portable terminal, a mobile terminal, a wired/wireless phone, a portable multimedia player (PMP), a personal digital assistant (PDA), a smart phone, or an MP3 player. Further, the terminal may include a near field communication module.

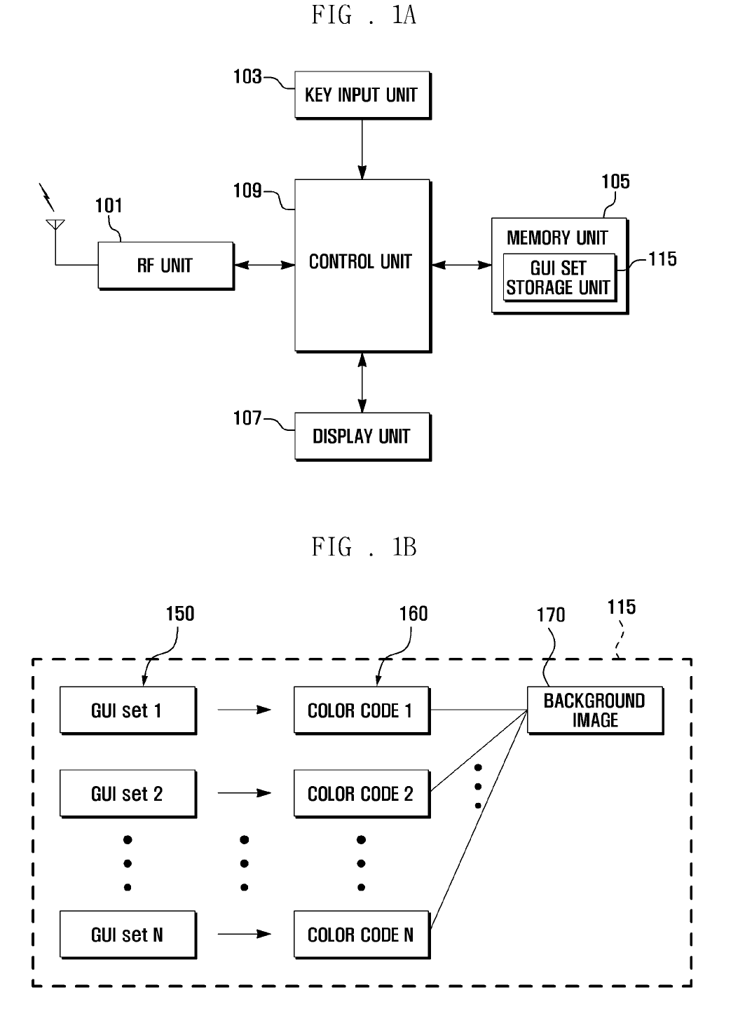

FIG. 1A is a block diagram showing a configuration of a terminal for configuring a GUI according to an exemplary embodiment of the present invention.

Referring to FIG. 1A, the terminal includes a radio frequency (RF) unit 101, a key input unit 103, a memory unit 105, a display unit 107, and a control unit 109.

The RF unit 101 performs a wireless communication function of the terminal. The RF unit 101 includes an RF transmitter to up-convert the frequency of a signal to be transmitted and amplify the signal, and an RF receiver to low-noise amplify a received signal and down-convert the frequency of the signal. In particular, the RF unit 101 transmits a GUI set.

Although a structure of a terminal having the RF unit 101 is described in the drawing of this exemplary embodiment, the present invention is not limited thereto. Alternatively, the RF unit 101 may be omitted. Further, a near field communication module, such as a Bluetooth® module, an Infrared Data Association (IrDA) module, an infrared module, a Zigbee module, or a radio communication module that can transmit and receive a signal by forming a communication channel in a short distance, may be included for transmission of information between terminals, for example, transmission of a GUI set.

The key input unit 103 receives a signal for operation of the terminal from a user's key operation. The key input unit 103 receives user key signals to perform key operations such as selection of a GUI configuring function, selection of a first mode or a second mode, selection of an image, selection of a color, and input of a GUI set name. Here, the selection of a color may include selection of hue, selection of brightness, or selection of opacity.

The memory unit 105 stores programs and information for operation of the terminal. The memory unit 105 stores a GUI element and an image. The GUI element may include a background image, a pattern image, a highlight, highlighted text, a pop-up, a title text, or a soft key character. The background image may be an image photographed by the user or an image received from another terminal. The pattern image is an image stored in the terminal in a manufacturing process of the terminal. The pattern image may be, for example, a black and white image.

The memory unit 105 includes a GUI set storage unit 115. The GUI set storage unit 115 stores a GUI set in a form shown in FIG. 1B. FIG. 1B is a block diagram showing a configuration of the GUI set storage unit 115 of the terminal of FIG. 1A. Referring to FIG. 1B, the GUI set storage unit 115 may store a plurality of GUI sets 150, each of which includes a color code 160 and a background image 170. A background image 170 may be used for more than one color code 160. Although only one background image 170 and the plurality of GUI sets 150 including a color code 160 are shown in the drawing, any GUI set including at least one color code matched with another background image may be stored.

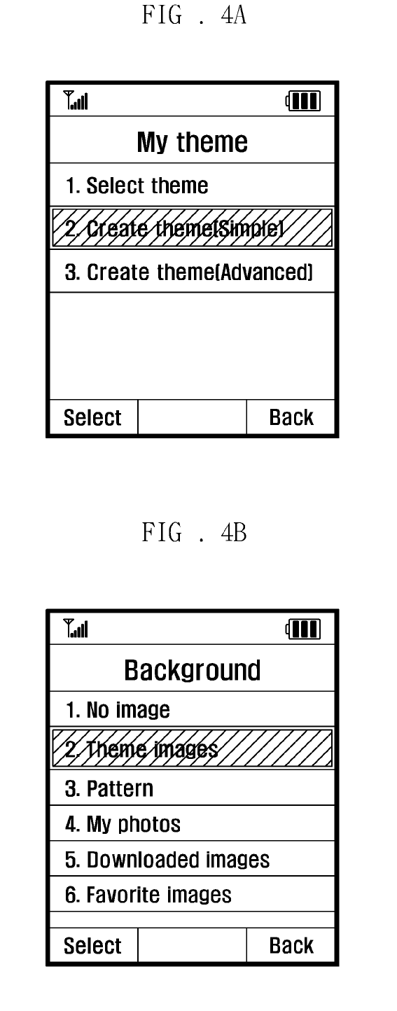

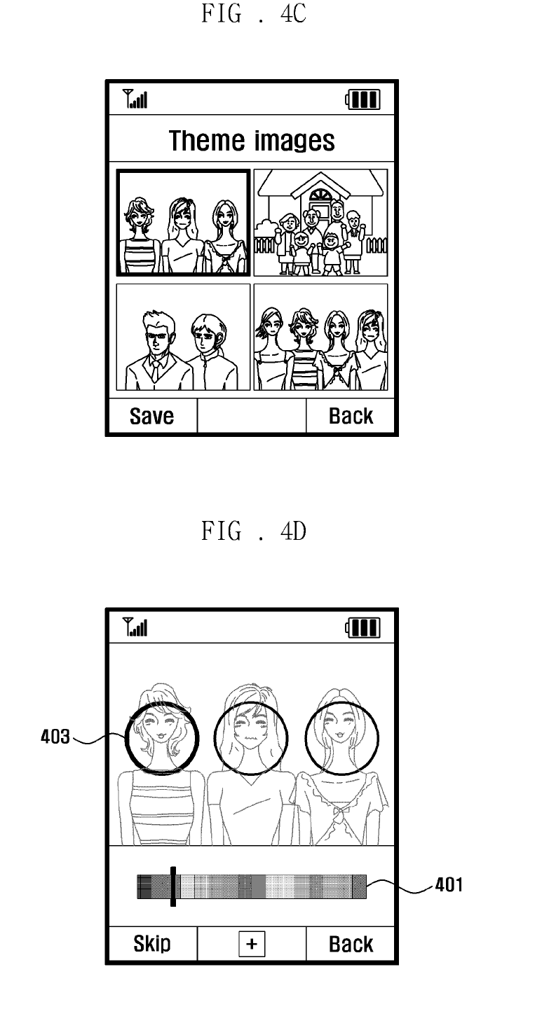

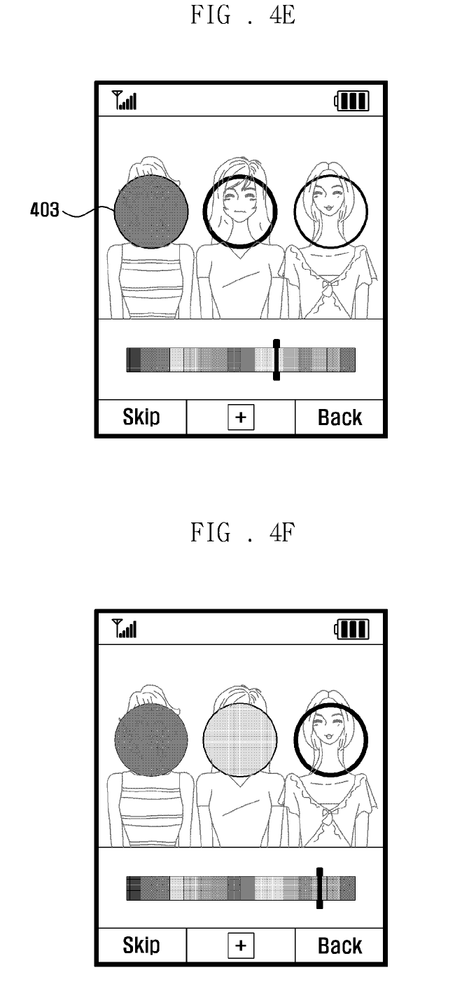

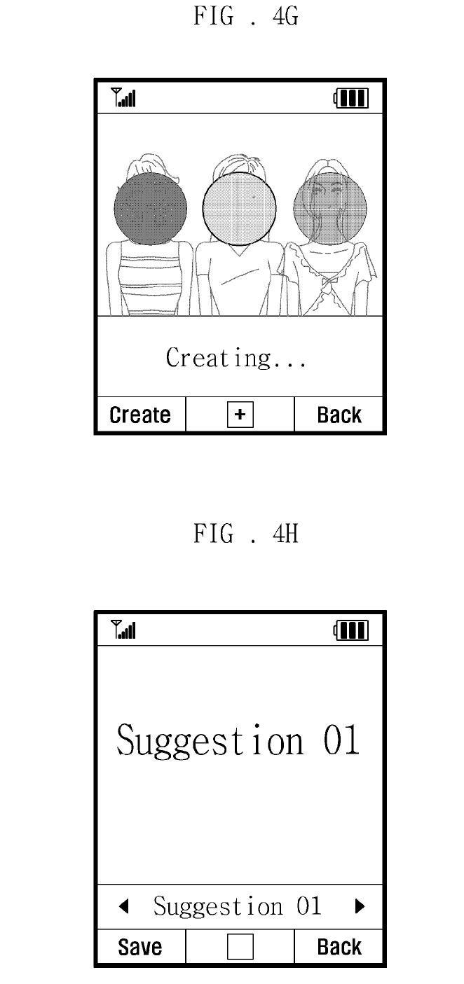

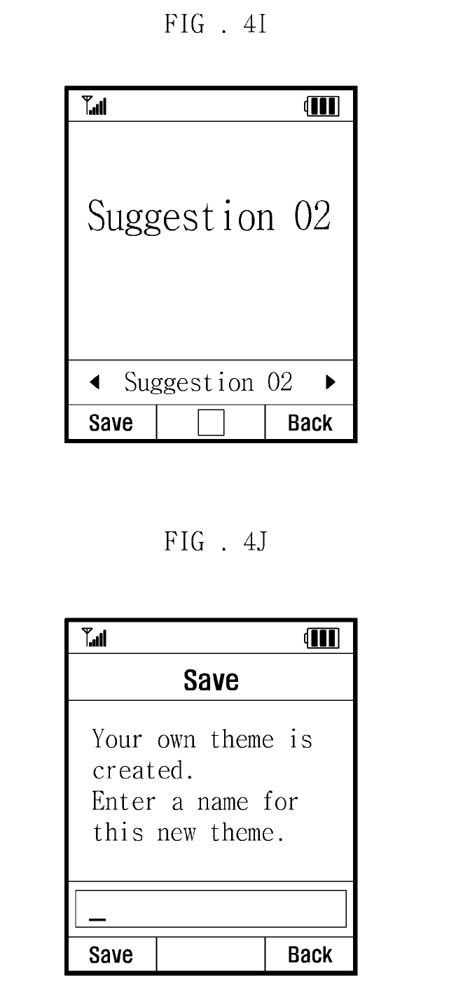

The display unit 107 optically displays a status of the terminal and information related to the operation of the terminal. When selecting a background image in a GUI configuring function, the display unit 107 displays stored images. In a first mode of the GUI setting function, the display unit 107 displays a hue control bar 401 shown in FIG. 4D for a color selection and displays the selected hue. Using the selected image and hue, the display unit 107 displays a preview screen of the resulting background image.

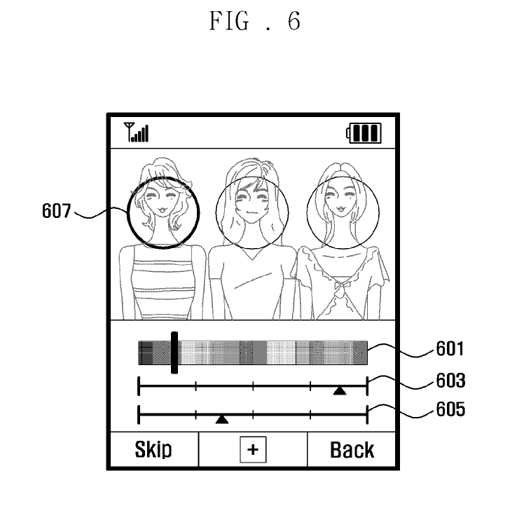

In a second mode of the GUI setting function, as shown in FIG. 6, the display unit 107 displays a hue control bar 601, a brightness control bar 603, and an opacity control bar 605 for color selection, and displays a color having the selected hue, brightness, and opacity. Using the selected image and color, the display unit 107 displays a preview screen of the resulting background image.

The display unit 107 may be a liquid crystal display (LCD). In this case, the display unit 107 includes an LCD control unit and an LCD device. The LCD may provide a touch screen function, in which the display unit 107 may be used as an input device.

The control unit 109 controls general functions of each element of the terminal. The control unit 109 controls the GUI configuring function. In the first mode of the GUI configuring function, the control unit 109 extracts a color code according to at least one of the selected image and color. The control unit 109 controls the color code by controlling brightness and opacity of the color code. By applying the controlled color code to a GUI element, the control unit 109 controls the display unit 107 to display a plurality of suggested images in a preview screen. If at least one suggested image is selected by the user, the control unit 109 stores the selected information as a GUI set in the GUI set storage unit 115.

In the second mode of the GUI configuring function, the control unit 109 receives selections of an image and a color for each GUI element. Here, the color may include hue, brightness, and opacity. The control unit 109 then displays a preview screen by applying the colors selected for individual GUI elements. If at least one color is selected by the user, the control unit 109 stores the selected information as a GUI set in the GUI set storage unit 115.

If transmission of a stored GUI set is requested by the user, the control unit 109 controls to transmit the requested GUI set through communicating unit. The communicating unit may be an RF unit, a Bluetooth® module, an IrDA module, an infrared module, or a Zigbee module. The control unit 109 may also receive a GUI set from another terminal. Alternatively, the control unit 109 may receive and update a GUI set from a server.

The control unit 109 may configure activation of a stored GUI set. If a specific event is generated, the control unit 109 may activate the stored GUI set according to the generated event.

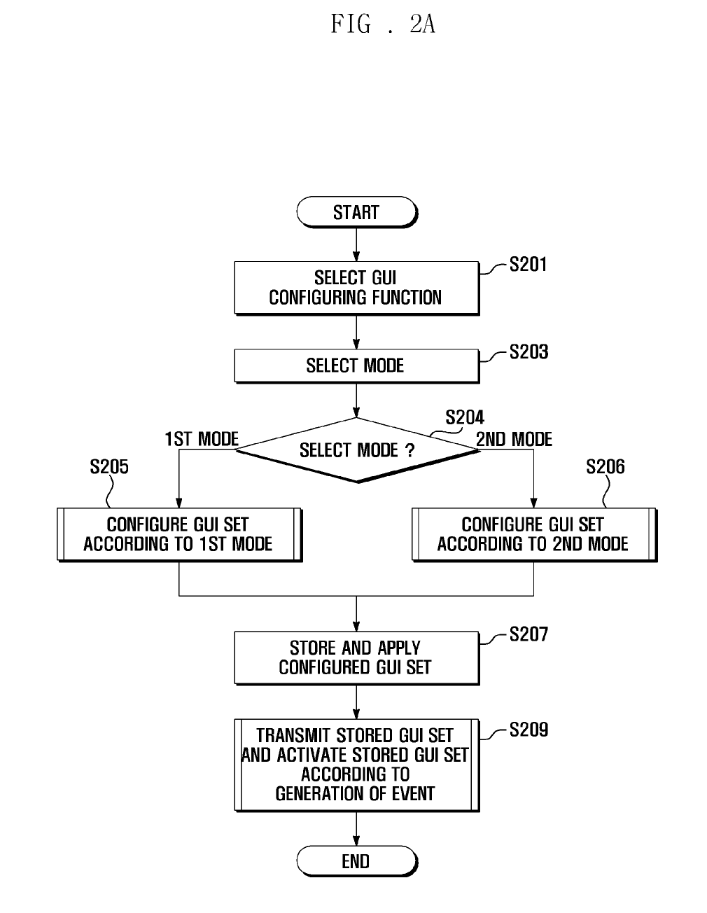

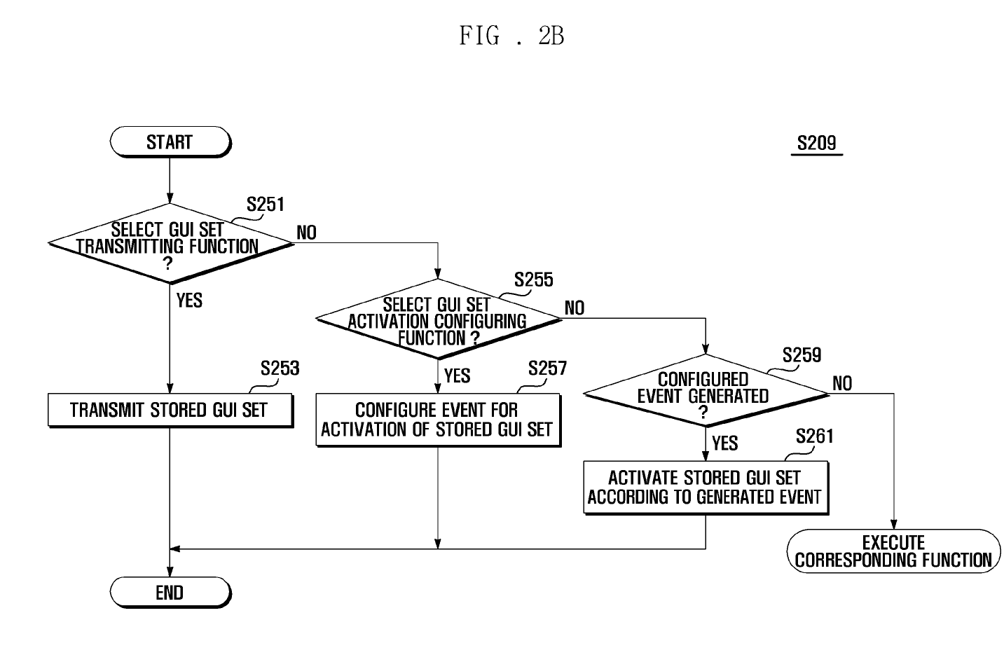

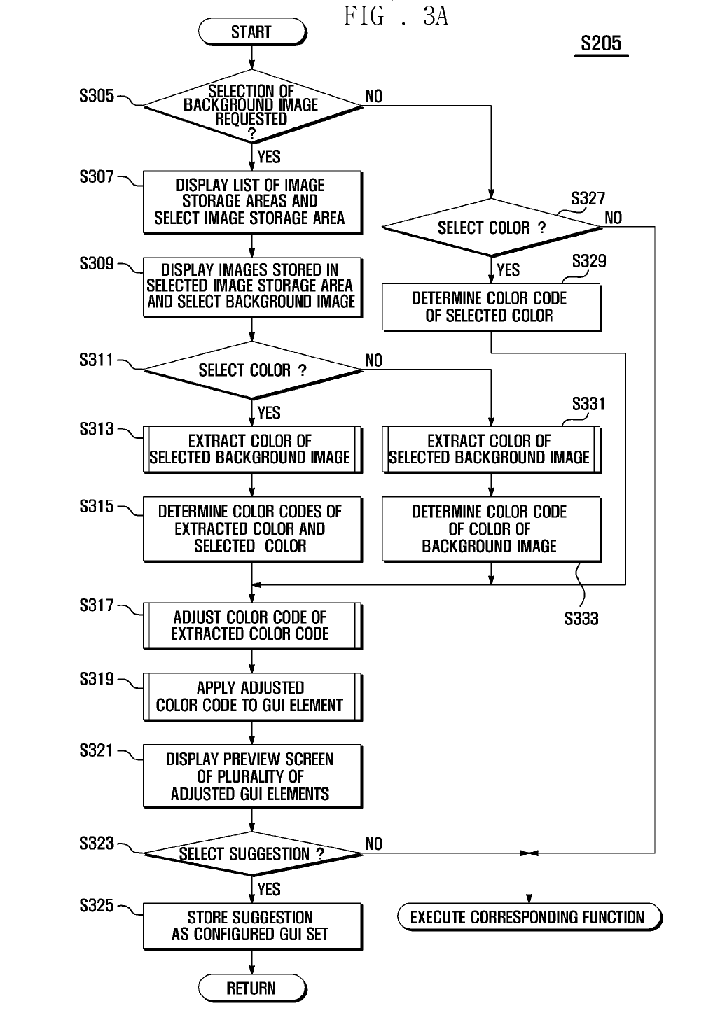

Hereinafter, a method for configuring a GUI in a terminal is described. FIG. 2A and FIG. 2B are flow charts showing a method of configuring a GUI in a terminal according to another exemplary embodiment of the present invention.

Referring to FIG. 2A, the control unit 109 first determines that a GUI configuring function is selected (S201). The user may select the GUT configuring function by inputting a menu key.

The control unit 109 determines that a mode is selected (S203). As described above, the GUI configuring function has a first mode and a second mode. The first mode is a mode for configuring a GUI in which the control unit 109 automatically applies selected information to a GUI element if a user selects an image or a color and configures the selected GUI. The first mode may be called a ‘basic mode’. The second mode is a mode for configuring a GUI in which the control unit 109 configures a selected GUI if the user selects an image and color for individual GUI elements, for example, hue, brightness, and opacity. The second mode may be called an ‘advanced mode’.

The control unit 109 determines which mode is selected (S204). If the GUI configuring function is selected at step S201, a menu is displayed as shown in FIG. 4A. Referring to FIG. 4A, two modes (basic mode and advanced mode) are provided in the menu. The user may select one of a first mode (basic mode) and a second mode (advanced mode) provided in the GUI configuring function.

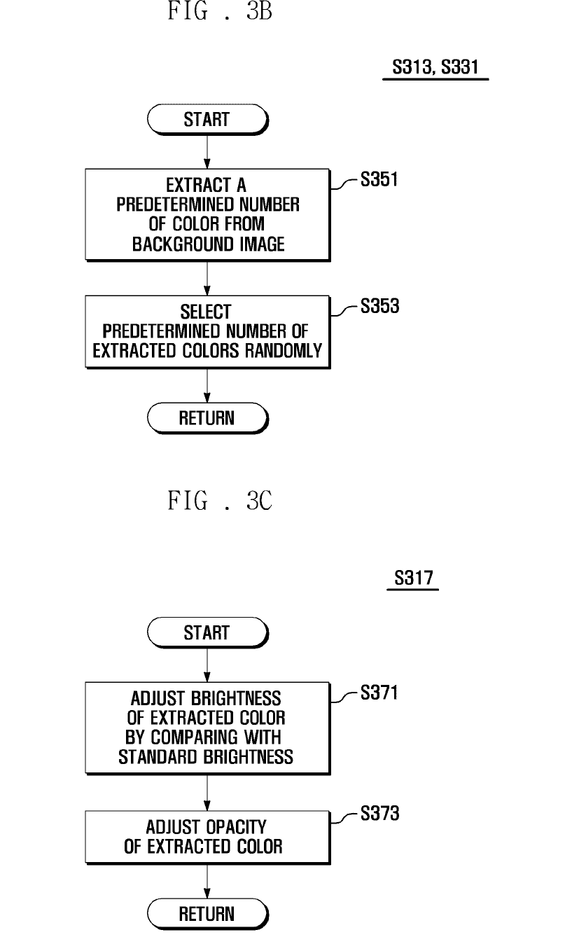

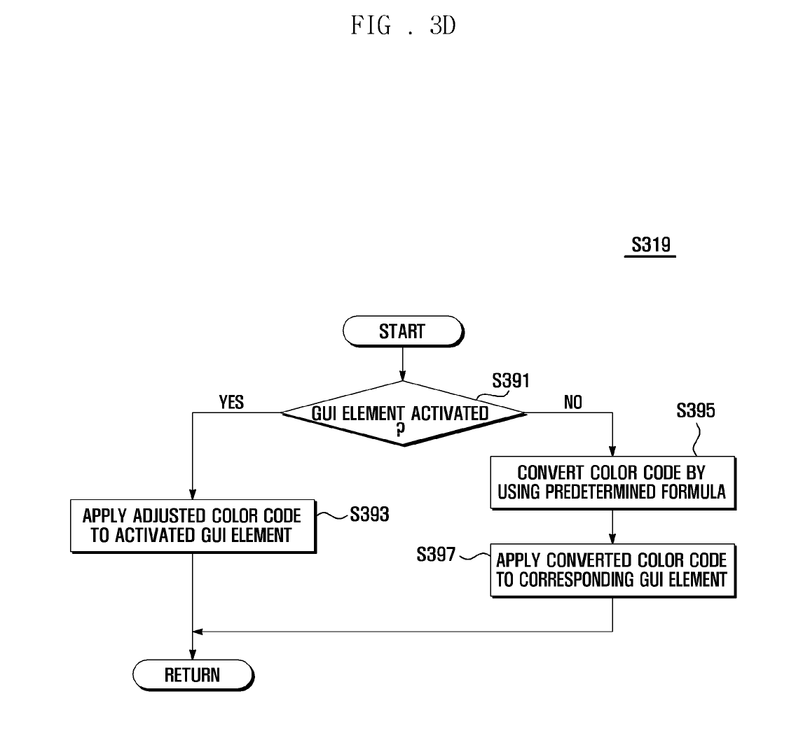

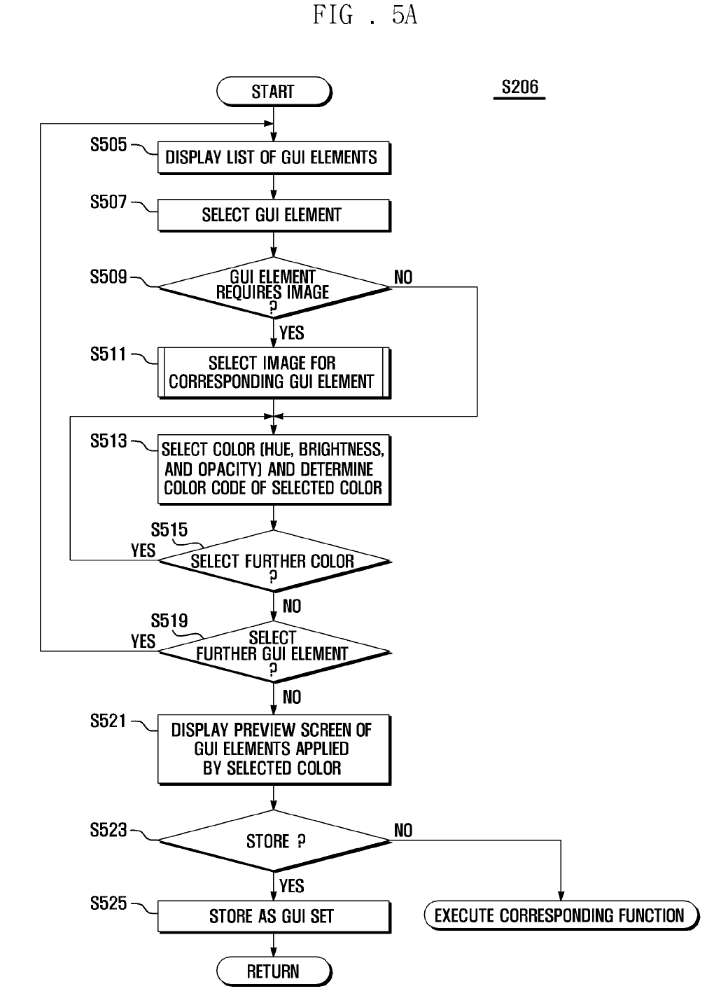

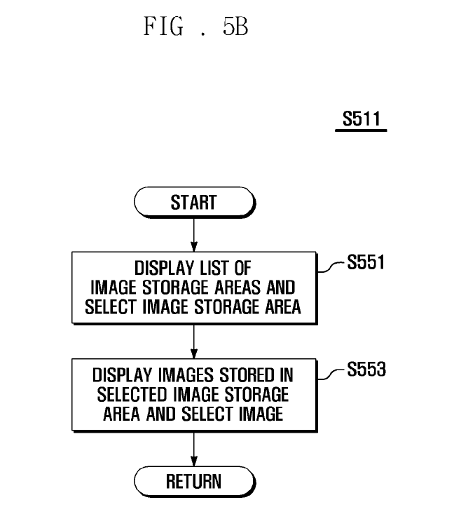

If the first mode is selected, the control unit 109 configures the GUI set according to the first mode (S205), and if the second mode is selected, the control unit 109 configures the GUI set according to the second mode (S206). Step S205 is described in more detail referring to FIG. 3A, and step S206 is described in more detail referring to FIG. 5A. The control unit 109 then applies the GUI set to a GUI element (S207).

The control unit 109 transmits the stored GUI set and activates the stored GUI set according to generation of an event (S209). This step is described in more detail referring to FIG. 2B.

Referring to FIG. 2B, the control unit 109 determines whether a GUI set transmitting function is selected (S251). The user may select the GUI set transmitting function by inputting a menu key.

If a GUI set transmitting function is selected, the control unit 109 transmits a stored GUI set (S253). The user may transmit a GUI set to a desired terminal through a communicating unit by selecting a GUI set to be transmitted.

If the GUI set transmitting function is not selected at step S251, the control unit 109 determines whether a GUI set activation configuring function is selected (S255). The user may select the GUI set activation configuring function by inputting a menu key.

If the GUI set activation configuring function is selected, the control unit 109 configures an event to activate a stored GUI set (S257). For example, the user may configure a specific GUI set to be activated by a group of stored telephone numbers such that the configured GUI set is activated when a call is received from a telephone in the group. Alternatively, a specific GUI set may be configured to be activated within a time period such that the configured GUI set is activated when the time period begins.

If the GUI set activation configuring function is not selected at step S255, the control unit 109 determines whether a configured event is generated (S259). The control unit 109 determines the generation of an event that is configured to activate a stored GUI set at step S257.

If a configured event is generated, the control unit 109 activates a corresponding GUI set configured according to the generated event (S261).

FIG. 3A, FIG. 3B, FIG. 3C, and FIG. 3D are flow charts showing the process of configuring a GUI in a first mode of step S205 in the method of FIG. 2A. FIG. 4A, FIG. 4B, FIG. 4C, FIG. 4D, FIG. 4E, FIG. 4F, FIG. 4G, FIG. 4H, FIG. 4I, and FIG. 4J are screens displayed while configuring a GUI in the first mode.

Referring to FIG. 3A, upon selection of the first mode by the user, the control unit 109 determines whether selection of a background image is requested (S305). In configuring a GUI set, the user may or may not select a background image.

If selection of a background image is requested, the control unit 109 controls the display unit 107 to display an image storage area list, and identifies a storage area selected by the user (S307). A screen example for performing this step is shown in FIG. 4B. Referring to FIG. 4B, a storage area list of images stored in the terminal is displayed. The user may select one from the list of storage areas.

The control unit 109 then controls the display unit 107 to display images stored in the selected storage area, and identifies an image selected by the user (S309). A screen example for performing this step is shown in FIG. 4C. Referring to FIG. 4C, the images stored in the selected storage area are arranged on the screen, and the user may select one of the displayed images as a background image.

Upon selection of a displayed image by the user, the control unit 109 determines whether a color is selected (S311). Screen examples of selecting a color are shown in FIG. 4D, FIG. 4E, FIG. 4F, and FIG. 4G. Referring to FIG. 4D, after the selection of a background image, the control unit 109 controls the display unit 107 to display a screen for selecting a color. The display unit 107 displays a hue control bar 401, and when a hue is selected by the user by adjusting the control bar 401, displays the selected hue in a specific area 403. In the screen of FIG. 4D, if the user further selects an add (+) key when a desired hue has been selected by adjusting the hue control bar 401, the newly selected hue is displayed in the specific area 403, as shown in FIG. 4E.

At this step, the user may select a plurality of colors. That is, the user may select a desired number of colors by adjusting the hue control bar 401. For example, 3 hues may be selected as shown in FIG. 4F and FIG. 4G. The control unit 109 then controls the display unit 107 to display the selected hues in the specific area 403.

If a color is selected at step S311, the control unit 109 further extracts a color from the selected background image (S313). Extracting a color at this step is for harmonization with the background image. Because the harmonization with the background image is improved by utilizing a color extracted from the background image, the GUI can be optimized by applying the background image to a GUI element.

Step S313 of extracting a color of a background image is described in more detail referring to FIG. 3B. Referring to FIG. 3B, the control unit 109 extracts a predetermined number of colors from the background image selected at step S309 (S351). For example, 9 colors may be extracted from 9 positions in the selected background image.

The control unit 109 selects a predetermined number of colors from the extracted colors (S353). For example, the control unit 109 may select 3 colors from the extracted 9 colors randomly.

After extracting the colors from the background image in steps S351 and S353, the process returns to the flow chart of FIG. 3A, and the control unit 109 determines color codes of the colors extracted from the background image and the selected colors (S315).

The control unit 109 adjusts a color code of the extracted color code (S317). This step is described in more detail referring to FIG. 3C. Referring to FIG. 3C, the control unit 109 adjusts the brightness of the extracted color by comparing the brightness of the extracted color with a standard brightness (S371). The control unit 109 then adjusts the opacity of the extracted color (S373). That is, the control unit 109 automatically adjusts the color codes of the color extracted from the background image and the color codes of the selected colors at step S315.

After adjusting the color codes of the extracted color codes in steps S371 and S373, the process returns to the flow chart of FIG. 3A, and the control unit 109 applies the adjusted color code to a GUI element (S319). This step is described in more detail with reference to FIG. 3D. Referring to FIG. 3D, the control unit 109 determines whether at least one GUI element is activated (S391).

If at least one GUI element is activated, the control unit 109 applies the adjusted color code to the at least one activated GUI element (S393).

If no GUI element is activated, the control unit 109 uses a predetermined formula to convert the adjusted color code to a color code for distinguishing an activated GUI element from a non-activated GUI element (S395). Here, the predetermined formula may be defined by a GUI designer in consideration of the clarity of image and aesthetic appreciation of the GUI elements. For example, the specific formula may be defined such that a converted color code including 30% of the extracted color code is applied to a non-activated GUI element. The control unit 109 then applies the converted color code adjusted by the predetermined formula to the corresponding GUI element (S397).

After applying the adjusted color code to a GUI element at step S319, the control unit 109 controls the display unit 107 to display a plurality of the adjusted GUI elements in a preview screen (S321). Screen examples of performing step S321 are shown in FIG. 4H and FIG. 4I. The control unit 109 creates a preview screen using a color code of the selected background image and a color code of the selected color, and applying it to a GUI element. As shown in FIG. 4H and FIG. 4I, the control unit 109 creates and controls the display of a plurality of suggested adjusted GUI elements using the selected background images and colors on a preview screen.

Here, the selected color may be overlaid on the background image or configured as a highlight color, a highlighted text color, a pop-up color, a title text color, or a soft key character color.

The control unit 109 determines whether a suggestion is selected from the preview screen (S323). The user may select a desired one from the displayed suggestions, for example Suggestion 01, shown in FIG. 4H.

If a suggestion is selected by the user, the control unit 109 stores the selected suggestion as a configured GUI set in the GUI set storage unit 115 (S325). A screen for storing a selected GUI set is shown in FIG. 4J. When storing a configured GUI set, the control unit 109 controls the display unit 107 to display an input field for entering a name of the GUI set, as shown in FIG. 4J.

The GUI set includes a background image selected at step S309 and a color selected at step S311, and the selected background image and the color code of the selected code are stored as a configured GUI set. Here, one or more suggestions may be selected. If a plurality of suggestions is selected, one background image and a plurality of color codes are stored as a plurality of configured GUI sets.

After performing step S325, the process returns to FIG. 2A and the configured GUI set may be applied according to the user's request at step S207.

If selection of a background image is not requested at step S305, the control unit 109 determines whether a color is selected (S327). The user may optimize a GUI set by selecting only the color without selecting a background image. Here, a plurality of colors may be selected by the user through the screens of FIG. 4D, FIG. 4E, FIG. 4F, and FIG. 4G. That is, if a hue is selected by the user through the hue control bar 401, the control unit 109 controls to display the selected hue in the specific area 403. Subsequently, the control unit 109 performs step S317 of adjusting the color code of the extracted color code. If a color is selected, the control unit 109 determines a color code of the selected color (S329).

If no color is selected at step S311, the control unit 109 extracts a color of the selected background image (S331). The user may configure the GUI set using only the background image without selecting a color. The process of extracting a color of the selected background image is performed in the same manner as described at step S313, with reference to FIG. 3B.

The control unit 109 then determines a color code of the selected background image (S333), and performs step S317.

Hereinafter, the process of configuring a GUI in a second mode of step S206 in the method of FIG. 2A is described. FIG. 5A and FIG. 5B are flow charts showing the process of configuring a GUI in a in a second mode in the method of FIG. 2A and FIG. 2B, and FIG. 6 is a screen example displayed while configuring a GUI.

The process of configuring a GUI in a second mode of step S206 is partially similar to the process of configuring a GUI in a first ode of step S205. However, when selecting a color, hue, brightness, and opacity may be directly selected by the user, and an image and a color desired by the user may be selected for individual GUI elements.

Referring to FIG. 5A, upon selection of the second mode by the user, the control unit 109 controls the display unit 107 to display a list of GUI elements (S505). Here, the GUI elements include a background image, a pattern image, a highlight, highlighted text, a pop-up, title text, and a soft key character. The user may configure an image and a color for individual GUI elements by selecting color characteristics, such as hue, brightness, and opacity.

The control unit 109 identifies whether a GUI element is selected (S507), and determines whether the selected GUI element requires an image (S509). Among the above GUI elements, the background image and pattern image are GUI elements requiring an image, and the remaining GUI elements do not require an image.

If the selected GUI element requires an image, the control unit 109 receives an image selected by the user for the corresponding GUI element (S511). This step is described in more detail referring to FIG. 5B. Referring to FIG. 5B, the control unit 109 controls the display unit to display a list of image storage areas, and identifies an image storage area selected by the user (S551). A screen example for performing this step is shown in FIG. 4B.

The control unit 109 then controls the display unit 107 to display images stored in the selected image storage area, and identifies an image selected by the user (S553). A screen example for performing this step is shown in FIG. 4C.

After selecting an image for the selected GUI element at steps S551, or if the selected GUI element does not require an image at step S509, the user selects a color and the control unit 109 determines a color code of the selected color (S513). Here, the color may include hue, brightness, and opacity. A screen example for performing this step is shown in FIG. 6. Referring to FIG. 6, the control unit 109 controls the display unit 107 to display a hue control bar 601, brightness control bar 603, and opacity control bar 605, together with the selected image if required by the selected GUI element. If a color is selected by the user, the selected color is displayed in a specific area 607. The control unit 109 then determines a color code of the selected color.

The control unit 109 identifies whether further color selection is requested (S515). The user may select a plurality of colors. If further color selection is requested, the control unit 109 returns to step S513 and determines a color code of a further selected color.

If no further color selection is requested at step S515, the control unit 109 identifies whether selection of further GUI element is requested (S519). After performing the above steps by selecting a GUI element, for example a background image, at step S507, the user may repeat the above steps by selecting another GUI element, for example, a highlight.

If selection of further GUI element is not requested, the control unit 109 controls the display unit 107 to display the selected GUI elements to which the corresponding selected color are applied in a preview screen on the display unit 107 (S521), as shown in FIG. 4H and FIG. 4I.

The control unit 109 determines whether a specific GUI element is to be stored (S523). If the user requests to store the GUI element, the control unit 109 stores the GUI element as a configured GUI set (S525). As shown in FIG. 4J, the user may store the configured GUI set in the GUI set storage unit 115 by inputting a name of the configured GUI set.

The GUI set includes an image selected at step S511 and a color selected at step S513, and the selected image and a color code of the selected color are stored as a configured GUI set. Here, one or more suggestions may be selected. If a plurality of suggestions is selected, one image and a plurality of color codes are stored as a plurality of configured GUI sets.

After performing step S525, the process returns to FIG. 2A and the configured GUI set may be applied according to the user's request at step S207.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for configuring a graphic user interface (GUI) in a terminal, comprising:
determining which one of a first mode and a second mode is selected when a GUI configuring function is selected;
selecting at least one of an image and a color if the first mode is selected;
selecting a color and, if an image is required, an image if the second mode is selected;
extracting a color code using the selected color and/or image;
configuring the extracted color code and the selected image as a GUI set; and
storing the GUI set and applying the GUI set to a GUI element.

2. The method of claim 1, wherein extracting a color code comprises:
determining whether selection of a background image is requested if the first mode is selected;
selecting the background image if selection of the background image is requested;
determining whether at least one color is selected;
extracting a color of the selected background image and determining color codes of the extracted color and the selected color if the at least one color is selected;
extracting a color of the selected background image and determining a color code of the extracted color if the at least one color is not selected; and
determining whether at least one color is selected if selection of the background image is not requested, and determining a color code of the selected color.

3. The method of claim 2, further comprising adjusting the color code of the extracted color.

4. The method of claim 3, wherein adjusting the color code of the extracted color comprises:
adjusting the brightness of the extracted color by comparing with a standard brightness;
adjusting the opacity of the extracted color; and
determining the color code of the extracted color after adjusting the brightness and the opacity of the extracted color.

5. The method of claim 3, wherein applying the GUI set to a GUI element comprises:
determining whether at least one GUI element is selected;
applying the adjusted color code to at least one GUI element if the at least one GUI element is selected;
converting the adjusted color code using a specific formula if no GUI element is selected, and applying the converted color code to non-selected GUI elements.

6. The method of claim 2, wherein extracting a color of the selected background image comprises:
extracting colors from positions in the selected background image; and
selecting a specific number of the extracted colors randomly.

7. The method of claim 1, wherein selecting an image and a color if a second mode is selected further comprises:
selecting a GUI element;
selecting an image from a plurality of stored images if the selected GUI element requires an image; and
selecting at least one color if the selected GUI element does not require an image.

8. The method of claim 7, further comprising:
determining whether another GUI element is selected after extracting the color code;
selecting at least one second color and, if the selected GUI element requires an image, a second image if the another GUI element is selected; and
extracting a color code using the selected second color and second image.

9. The method of claim 7, wherein selecting the at least one color comprises selecting a hue, selecting a brightness, and selecting an opacity.

10. The method of claim 7, wherein the GUI element comprises at least one of a background image, a pattern image, a highlight, highlighted text, a pop-up, title text, and a soft key character.

11. The method of claim 10, wherein applying the GUI set to a GUI element comprises:
overlaying the selected color on the selected image when the GUI element comprises a background image;
replacing a color of the selected image with the selected color when the GUI element comprises a pattern image;
configuring the selected color as a highlight color when the GUI element comprises a highlight;
configuring the selected color as a highlight text color when the GUI element comprises a highlighted text;
configuring the selected color as a pop-up color when the GUI element comprises a pop-up;
configuring the selected color as a title text color when the GUI element comprises a title text; and
configuring the selected color as a soft key character color when the GUI element comprises a soft key character.

12. The method of claim 1, wherein storing the GUI set comprises storing an image and a color code as a GUI set.

13. The method of claim 1, further comprising transmitting a stored GUI set through a communicating unit when a GUI set transmitting function is selected after applying the GUI set to the GUI element.

14. The method of claim 1, further comprising:
configuring an event to activate a stored GUI set when a GUI set activation configuring function is selected after applying the GUI set to the GUI element; and
activating the corresponding GUI set if the configured event is generated.

15. A terminal, comprising:
a memory unit to store a GUI element, an image, and color information;
a control unit to select at least one of an image and color if a first mode of a GUI configuring function is selected, to select a color and, if an image is required, an image if a second mode of the GUI configuring function is selected, to extract a color code using the selected color and/or image, to configure the extracted color code and the selected image as a GUI set, and to apply the GUI set to the stored GUI element; and
a GUI set storage unit to store the GUI set.

16. The terminal of claim 15, wherein the control unit extracts a color of the selected background image if a background image and at least one color are selected in the first mode and determines color codes of the extracted color and the selected color, extracts a color of the selected background image and determines a color code of the extracted color if a background image only is selected in the first mode, and determines a color codes of the selected color if no background image is selected and at least one color is selected.

17. The terminal of claim 16, wherein the control unit adjusts the color code of the extracted color by adjusting a brightness and an opacity of the extracted color.

18. The terminal of claim 17, wherein the control unit applies the adjusted color code to at least one GUI element if the at least one GUI element is selected, and converts the adjusted color code using a specific formula if the at least one GUI element is not selected and applies the converted color code to non-selected GUI elements.

19. The terminal of claim 16, wherein the control unit extracts colors from positions in the selected background image, and selects a specific number of the extracted colors randomly.

20. The terminal of claim 15, wherein the control unit selects a GUI element in the second mode, selects an image and at least one color if the selected GUI element requires an image, selects at least one color if the selected GUI element does not require an image, extracts a color code of the selected color, and stores the selected image and the color code of the selected color as a GUI set.

21. The terminal of claim 20, wherein the control unit selects the color by selecting a hue, a brightness, and an opacity.

22. The terminal of claims 15, wherein the GUI set storage unit stores an image and a color code as a GUI set.

23. The terminal of claim 15, further comprising a communicating unit to transmit a stored GUI set to another terminal.

24. The terminal of claim 15, wherein the control unit configures an event to activate a stored GUI set, and activates the stored GUI set when the configured event is generated.
